(19) United States
(12) Patent Application Publication
(10) Pub. No.: US 2026/0311588 A1
(43) Pub. Date: Oct. 8, 2026

(54) Smoke Alarm Disabling Device

(71) Applicant: Roger E. Kaufman, McLean, VA (US)

(72) Inventor: Roger E. Kaufman, McLean, VA (US)

(21) Appl. No.: 19/173,053

(22) Filed: Apr. 8, 2025

(51) Int. Cl. G08B 25/00; G08B 17/10

(52) U.S. Cl. CPC G08B 25/008; G08B 17/10

(57) ABSTRACT

A smoke alarm disabling device includes an elongated handle and a cover such as a bag mounted on an end of the handle. An actuator in the form of a core is connected to the bag and is supported by the handle for movement with respect to the handle in a lengthwise direction of the core. The core can be translated with respect to the handle to expand or contract the open end of the bag. The open end of the bag can be placed over a wall-mounted or ceiling-mounted smoke alarm and the core can be translated to grasp the smoke alarm with the open end of the bag and cover the smoke alarm and prevent the smoke alarm from being activated by smoke. The bag can be removed from the smoke alarm when not needed by translating the core to expand the open end of the bag.

### BACKGROUND OF THE INVENTION

This invention relates to a smoke alarm disabling device which can temporarily disable a smoke alarm.

A recent report from the NFPA (National Fire Protection Association) found that an average of 403 deaths occur annually due to non-working smoke alarms. Missing, dead, or disconnected batteries and disconnected hardwired alarms are the most common factors in these fires. Generally, these smoke alarms were deliberately disabled to avoid nuisance due to a smoke alarm in or near the kitchen sounding too often during cooking and not due to an actual fire. Accordingly, there is a need for a simple device for temporarily disabling a smoke alarm and easily reenabling the smoke alarm when there is no longer any need to disable it.

### SUMMARY OF THE INVENTION

The present invention provides a smoke alarm disabling device which can temporarily disable a smoke alarm in situations in which it would be inconvenient for the smoke alarm to be activated.

The present invention also provides a method of temporarily disabling a smoke alarm.

According to one form of the present invention, a smoke alarm disabling device includes a cover which is impervious to smoke and is sized to fit over a smoke alarm and has an open end which can be expanded and contracted. The cover is supported by an elongated handle, and an actuator is supported by the handle and extends in a lengthwise direction of the handle. The actuator is operatively connected to the open end of the cover to switch the open end of the cover between an expanded state and a contracted state when an axial force is applied to the actuator.

According to another form of the present invention, a method of using a smoke alarm disabling device according to the present invention includes positioning the cover of the device opposite a smoke alarm using the handle with the open end of the cover in an expanded state. The cover is placed over the smoke alarm until the open end of the cover surrounds the smoke alarm and then the actuator is operated to contract the open end of the cover around the smoke alarm to form a seal between the cover, the surface on which the smoke alarm is mounted, and the smoke alarm.

In preferred embodiments, the cover comprises a flexible bag which is mounted at an end of the handle and has an open end, and the actuator comprises an elongated member which is flexible over at least a portion of its length. If a smoke alarm goes off in a situation in which there is no actual danger of a fire, such as due to cooking smoke in a kitchen or due to a candle being blown out, the bag can be waved by a user in the vicinity of the smoke alarm to dissipate the smoke and silence the smoke alarm. The user can then manipulate the smoke alarm disabling device to seal the bag around the smoke alarm until the need for covering the smoke alarm is over, at which point the device can be easily removed from the smoke alarm.

### BRIEF DESCRIPTION OF THE DRAWINGS

FIG. 1 provides a pictorial overview of an embodiment of a smoke alarm disabling device according to the present invention together with a typical smoke alarm.

FIG. 2 shows the details of the bag of the embodiment of FIG. 1.

FIG. 3 shows the handle of the embodiment of FIG. 1, and FIG. 4 shows cut-away portions of the handle in expanded detail.

FIG. 5 shows an axially stiff flexible core of the embodiment of FIG. 1, and FIG. 6 shows portions of the core in expanded detail.

FIG. 7 is a pictorial view of the embodiment of FIG. 1 showing the opening of the bag in an expanded state.

FIG. 8 is a pictorial view from above of the embodiment of FIG. 1 surrounding a typical circular smoke alarm.

FIG. 9 is an axonometric view from below of a typical rectangular smoke alarm mounted on a ceiling, and FIG. 10 shows a view from above of the embodiment of FIG. 1 with the open end of the bag locked around a smoke alarm such as the one shown from below in FIG. 9.

FIG. 11 is a pictorial view showing another embodiment of a smoke alarm disabling device for use with wall-mounted smoke alarms.

FIG. 12 is a pictorial view showing an embodiment of a smoke alarm disabling device with an adjustable joint allowing it to be used with either ceiling-mounted or wall-mounted smoke alarms.

FIG. 13 is a pictorial view showing another embodiment of a smoke alarm disabling device having a straight tubular shaft for use with wall-mounted smoke alarms.

FIG. 14 shows another example of a bag which can be used with a smoke alarm disabling device according to the present invention.

FIG. 15 is a pictorial view of another embodiment of a smoke alarm disabling device for use with either wall-mounted or ceiling-mounted smoke alarms.

FIG. 16 shows the embodiment of FIG. 15 being used to engage a ceiling-mounted smoke alarm.

FIG. 17 shows the embodiment of FIG. 15 being flexed and manipulated by a user until the bag fully surrounds a smoke alarm and the open end of the bag is in full contact with the mounting surface for the smoke alarm.

FIG. 18 shows the embodiment of FIG. 15 being tightened around a smoke alarm by manipulating a grippable member.

FIGS. 19 and 20 show examples of a cover of a smoke alarm disabling device in which some portions of the cover are rigid and other portions are flexible.

FIG. 21 illustrates an example of a bag for a smoke alarm disabling device equipped with a coil compression spring to expand the open end of the bag.

FIG. 22 illustrates the coil compression spring of FIG. 21 removed from the bag 302.

FIG. 23 illustrates an embodiment of a smoke alarm disabling device equipped with the bag shown in FIG. 21.

FIG. 24 shows an example of a bag of a smoke alarm disabling device in which a wavy spring or other flexural member is used to expand the open edge of a bag.

FIG. 25 shows another example of a core of a smoke alarm disabling device according to the present invention in which some portions of the core are rigid and other portions are flexible but axially stiff.

FIG. 26 is a pictorial view of an embodiment of a smoke alarm disabling device using the core shown in FIG. 25.

FIG. 27 shows an embodiment of a smoke alarm disabling device suited for manipulation by a user employing a single hand.

FIG. 28 shows an embodiment of a smoke alarm disabling device using spring-loaded fingers to contract the open end of a bag around a smoke alarm.

FIG. 29 shows the upper portion of an embodiment of a smoke alarm disabling device having a bag with an open end in an expanded state.

FIG. 30 is another view of the upper portion of the embodiment of FIG. 29 with the open end of the bag in a contracted state.

FIG. 31 is another view of the upper portion of the embodiment of FIG. 29 with the bag omitted for clarity.

### DESCRIPTION OF PREFERRED EMBODIMENTS

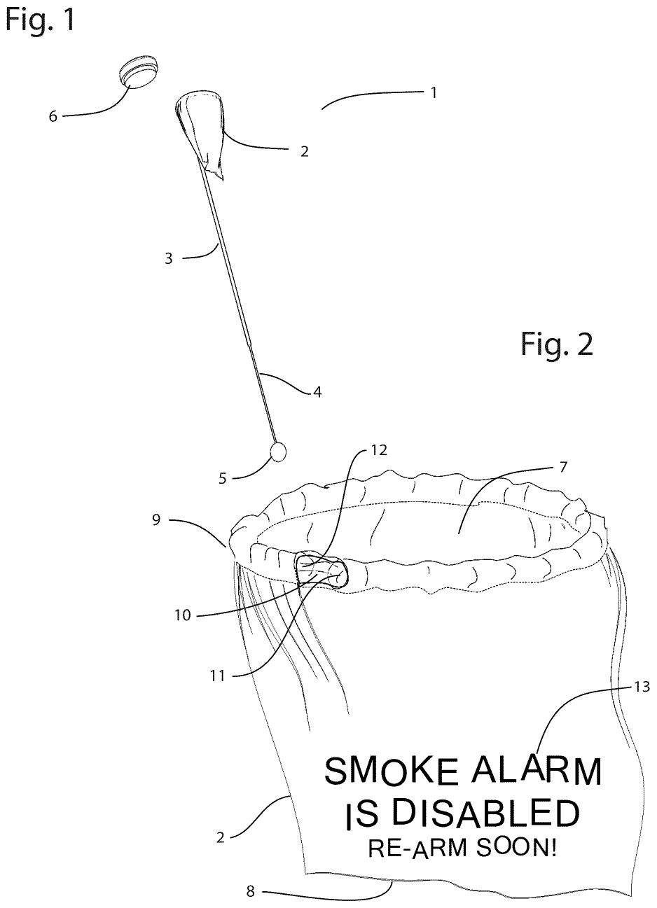

A number of embodiments of a smoke alarm disabling device according to the present invention will next be described while referring to the accompanying drawings. FIG. 1 provides a pictorial overview of a first embodiment of a smoke alarm disabling device 1. The illustrated embodiment includes a cover (shown as a bag 2), a handle 3 which supports the cover, and an actuator 4 for operating the cover. A typical ceiling-mounted smoke alarm is indicated by reference number 6 in FIG. 1.

The cover is a member which can be placed over a smoke alarm to prevent the smoke alarm from sounding when smoke is present in the air surrounding the smoke alarm. The cover is made of a material which is resistant or impervious to the passage of smoke through the cover. The cover includes an open end which can be expanded to enable the open end to fit over a smoke alarm and contracted to enable the open the end to fit snugly around a smoke alarm. While the cover is not limited to any particular structure, a flexible bag is often a convenient form of cover because of its simplicity and ease of use.

The cover may be largely rigid, largely flexible, or it may have a combination of rigid and flexible portions. Examples of materials which are impervious to smoke are solid plastics or metals or plastic films or membranes. Examples of materials which are resistant to the passage of smoke are woven and non-woven fabrics having the ability to filter smoke particles from air. Some specific examples of materials which are resistant to the passage of smoke are tightly woven fabrics, filter materials used for air filters and air conditioning systems or other machinery, and materials used for surgical masks and other types of masks.

The handle 3 is an elongated member having a rigidity which enables a user to position the bag 2 or other type of cover with respect to a smoke alarm while holding the handle 3. The handle 3 preferably has a length such that when the smoke alarm disabling device 1 is mounted on a smoke alarm, the disabling device 1 can hang beneath the smoke alarm with the lower portions of the handle 3 at a convenient height to be manipulated by the user, such as at the height of a typical adult's head or shoulders. The handle 3 is not restricted to any particular form, but in the present embodiment, the handle 3 is a hollow member having a bore extending over its entire length.

The actuator can have any structure which enables a user to expand and contract the open end 7 of the bag 2 by manipulating the actuator. In this embodiment, the actuator comprises an elongated flexible core 4 which is slidably disposed inside the bore in the handle 3 for translation in the lengthwise direction of the core 4.

FIG. 2 shows the bag 2 in greater detail. The bag 2 has an adjustable open end 7 and a closed end 8 and is sized to fit over a typical smoke alarm 6. The open end 7 includes a passageway 9 for the core 4. In this embodiment, the passageway 9 is defined by a hem, but it may be defined by other structures such as loops of fabric like the belt loops of trousers, rings, or a tubular member attached to the open end of the bag 2. The passageway 9 includes at least one open portion 10 providing access from the outside of the passageway 9 to the inside. The passageway 9 has a first opening 11 and may have one or more second openings 12.

Here, proximal refers to the portion or end of a component closest to the bag 2 or other type of cover and distal refers to the portion further from the bag 2.

The core 4 also enters the passageway 9 in the open end 7 of the bag 2 through the first opening 11 and curves around within the passageway 9. The proximal end 18 of the core 4 may then exit from the passageway 9 through the second opening 12, or it may terminate within the passageway 9 in that region. The proximal end 18 of the core 4 then either terminates by being attached to the side of the handle 3 near the second opening 12 of the passageway 9 or by being attached to the bag 2 itself in that region. This attachment can be done by any convenient method using cement, a clamp, a knot, or other well-known technique.

As shown in FIG. 2, the bag 2 may optionally be imprinted with a suitable warning label 13 to indicate that the smoke alarm is currently disabled due to the presence of the smoke alarm disabling device 1. Further, the bag 2 may be brightly colored to indicate the danger of leaving the smoke alarm disabling device 1 in place longer than necessary.

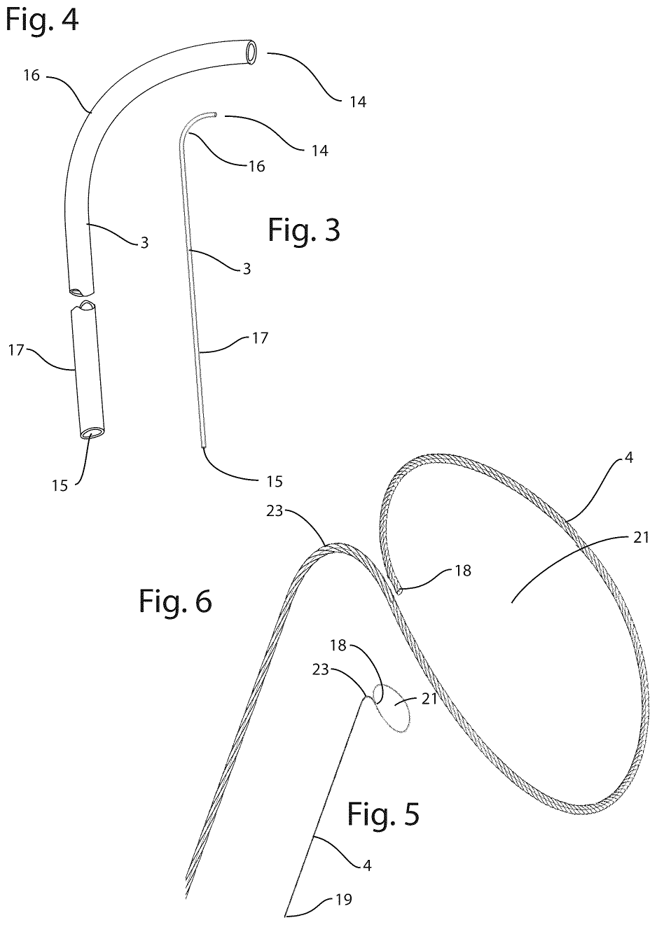

FIGS. 3 and 4 show the handle 3 of the embodiment of FIG. 1. In this embodiment, the handle 3 includes a curved portion 16 and a straight portion 17 and provides an unobstructed internal passageway from the proximal end 14 to the distal end 15 of the handle 3. Both ends 14 and 15 of the handle 3 are open to allow the core 4 to pass through the ends.

Portions of the bag 2 near the first opening 11 may be cemented or otherwise affixed to the proximal end 14 of the handle 3 to hold that portion of the bag 2 to the handle 3. In this embodiment, the proximal end 14 of the handle 3 enters partially into the passageway 9 of the bag 2 through the first opening 11 and is affixed to the bag 2 in this region.

The overall length of the handle 3 is preferably such that when the smoke alarm disabling device 1 is in use (with the proximal end 14 of the handle 3 pressing the open end 7 of the bag 2 against a ceiling), the distal end 15 of the handle 3 will be at a convenient height allowing a user to grasp the distal end 15 with one hand.

Portions of the handle 3 near its distal end 15 may be padded to provide a gripping surface for the user and to prevent injury if a person were to accidentally bump into the handle 3 while the smoke alarm disabling device 1 is in use. In the event of such a collision, the handle 3 would be unlikely to produce any injury since it would safely swing out of the way because the material of the bag 2 would deflect or bend and the handle 3 is only attached to the material forming the bag 2.

Further, portions of the handle 3 may be brightly colored or imprinted with warning messages to prevent a person from accidentally bumping into the handle 3 and to serve as a reminder to remove the smoke alarm disabling device 1 from the smoke alarm 6 if the device 1 is no longer needed.

FIGS. 5 and 6 show the core 4 of this embodiment in detail. Some non-limiting examples of materials which can be used for the core 4 are metal wire, a flexible spline of any cross section, extruded plastic tubing, extruded plastic line, and wire rope. The core 4 is preferably bendable but provides axial stiffness along its length so as to be able to act in both tension and compression. In this embodiment, the core 4 has a uniform flexibility over its entire length, but it is also possible for the core 4 to have varying flexibility along its length, such as with the proximal portion being axially stiff but bendable and the distal end being rigid. The bending stiffness of the core 4 is preferably selected so that at least the portion of the core 4 disposed within the passageway 9 of the bag 2 can be bent around the periphery of a typical smoke alarm.

The core 4 passes through both the handle 3 and the passageway 9 in the bag 2. The distal end 19 of the core 4 passes out of the handle 3 through the opening in the distal end 15 of the handle 3, and the proximal end 18 of the core 4 exits the handle 3 through the opening in the proximal end 14 of the handle 3 and then enters the passageway 9 of the bag 2 through the first opening 11 of the passageway 9.

The core 4 passes further through the passageway 9 curving around while conforming to the constraints provided by the passageway 9 until it terminates in the vicinity of the proximal end 14 of the handle 3. In this embodiment, the proximal end 18 of the core 4 passes out of the passageway 9 through the second opening 12 of the passageway 9. It is also possible for the proximal end 18 of the core 4 to remain within the passageway 9 and for the passageway 9 to have a closed end, with the second opening 12 being omitted.

In this embodiment, the proximal end 18 of the core 4 is affixed to the handle 3 near the proximal end 14 of the handle 3. It is also possible for the proximal end 18 of the core 4 to be attached to the hem of the bag 2 in that region. The attachment of the proximal end 18 of the core 4 to either the bag 2 or the proximal end 14 of the handle 3 in the vicinity of the second opening 12 of the bag 2 ensures that the core 4 will not pull out of the bag 2 or push further out of the passageway 9 through the second opening 12 when the smoke alarm disabling device 1 is manipulated by a user.

Due to the bending stiffness of the core 4, it will tend to spring out into an approximately circular shape when confined within the passageway 9 of the bag 2. FIGS. 5 and 6 illustrate pictorially the approximate shape of the core 4 when it is fully inserted into the handle 3 and constrained both by the handle 3 and the passageway 9 of the bag 2. In this state, the portion of the core 4 within the passageway 9 of the bag 2 will expand to form a hoop surrounding a region 21 large enough to pass around a typical smoke alarm 6.

The core 4 can slide within the constraints provided by the handle 3 but is guided and prevented from buckling sideways due to the tubular portions of the handle 3. Once the proximal portions of the core 4 have exited the opening at the proximal end 14 of the handle 3, the flexible portions of the core 4 are free to buckle sideways but are constrained by the passageway 9 to buckle in the form of a loop 21 whose size is determined by the length of the core 4 lying within the passageway 9.

The handle 3 need not be tubular as shown in FIGS. 3 and 4 but could have portions with holes, loops or other guiding constraints surrounding parts of the core 4. These surrounding portions of the handle 3 could be used to guide the portions of the core 4 between the proximal end 14 of the handle 3 and the distal end 15 and prevent the core 4 from buckling or otherwise pulling out of position. Thus, it is possible for the core 4 to be supported on the exterior of the handle 3 instead of being disposed inside the handle 3.

As stated above, the core 4 could have a structure that is partially flexible and partially rigid along its length. The proximal end of the core 4 needs to be flexible to allow it to bend and assume a curved shape 23 as it passes through the curved portion 16 of the handle 3 and also as it curves around in the region within the passageway 9 of the bag 2. The portions of the core 4 which always pass within the straight portion 17 of the handle 3 never need to bend, so they can be stiffened or made completely rigid.

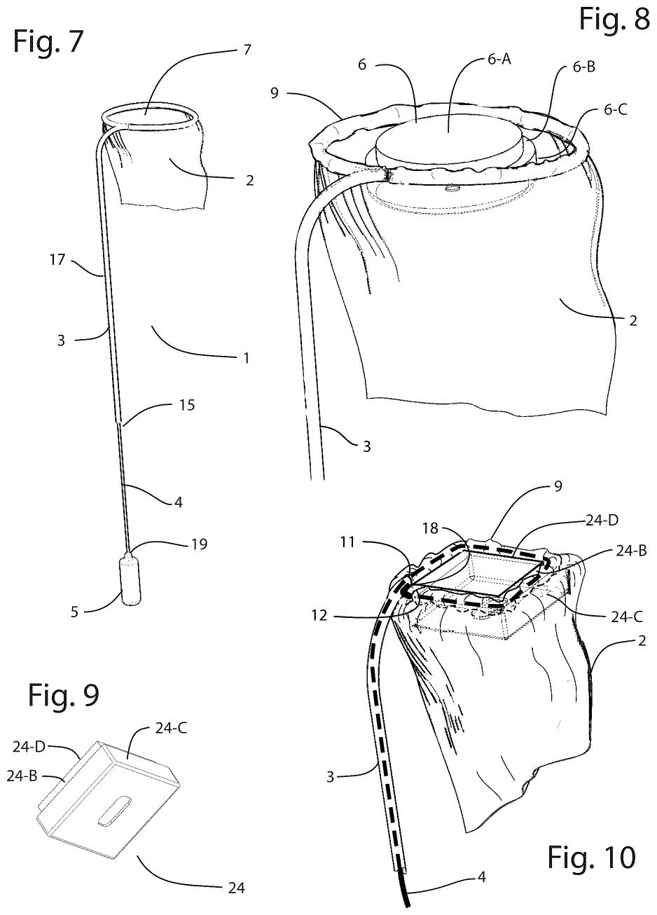

FIG. 7 is a pictorial view of the embodiment of FIG. 1 as it would appear when held by a user with the open end 7 of the bag 2 at the top of the device 1. In this figure, the user would be holding the distal end 15 of the handle 3, and the distal end 19 of the core 4 is protruding from the bottom of the handle 3. In this example, a grippable member 5 such as a knob, a handle, a ring, a loop, or the like is shown attached to the distal end 19 of the core 4 to provide a convenient grip for the user and to provide protection in the event of an occupant of the room accidentally bumping into the end of the device1.

Labels, ribbons, or other markings could also be incorporated and attached to either the grippable member 5 or to other suitable portions of the smoke alarm disabling device 1 to provide a reminder to remove the device 1 when it is no longer needed and to provide a tactile reminder to remove the device 1 in such a situation should an occupant of the room accidentally collide with the lower portions of the smoke alarm disabling device 1.

FIG. 8 shows how a user can position the smoke alarm disabling device 1 around a typical smoke alarm 6 when the smoke alarm 6 is mounted on a ceiling (not shown). In this illustration, the distal portion of the core 4 has been pushed into the handle 3 as far as possible by means of the grippable member 5 attached to the distal end of the core 4. As a result, the opening 7 of the bag 2 has been expanded into a ring or hoop that can be slipped over the smoke alarm 6 until portions of the bag 2 near the passageway 9 are pressed against the ceiling on which the top surface 6-A of the smoke alarm 6 is mounted. While the straight portion 17 of the handle 3 is held in this position with one hand, the user can pull down on the grippable member 5 of the core 4, thereby contracting the open end 7 of the bag 2 and causing the upper portions of the bag 2 surrounding the passageway 9 to press tightly against the upper portions of the periphery of the smoke alarm 6.

Typically, smoke alarms have an upper ledge region with an inner wall 6-B near which unillustrated portals allow smoke to enter and activate sensors within the smoke alarm. When used with such a smoke alarm, the contracted open end 7 of the bag 2 can advantageously grip this portion of the smoke alarm 6. Even if such a ledge does not exist on the smoke alarm 6, friction between portions of the inner surface of the open end 7 of the bag 2 and the outer wall surfaces 6-C of the smoke alarm 6 will still hold the bag 2 and the disabling device 1 in place due to the light weight of the smoke alarm disabling device 1.

When the smoke alarm disabling device 1 is locked securely around the mounting portions of a smoke alarm 6, portions of the bag 2 surrounding the open end 7 will provide a seal to the mounting surface of the smoke alarm, which in this case is the top surface 6-A of the smoke alarm 6. The ceiling surface then acts as a closure to the open end 7 of the bag 2, with the upper portions of the open end 7 pressed against the ceiling and providing a seal against the ceiling. The bag 2 then provides an impervious block preventing smoke from reaching the smoke alarm 6. Thus, the smoke alarm 6 will not be affected by cooking smoke or other fumes while the smoke alarm disabling device 1 is left in position on the smoke alarm 6.

In order to prevent the open end 7 of the bag 2 from expanding due to the elasticity of the portion of the core 4 within the passageway 9 after the bag 2 has been tightened around a smoke alarm and coming loose from the smoke alarm when a user releases his hand from the core 4, the smoke alarm disabling device 1 may be designed to resist movement with respect to the handle 4 of the portion of the core 4 within the handle 3 when no axial force is being applied to the core 4 by the user. For example, the diameter of the bore in the handle 3 can be selected to produce sufficient friction between the inner surface of the bore and the outer surface of the core 4 to prevent inadvertent translation of the core 4 with respect to the handle 3 due to the elasticity of the core 4. Another possibility is for a simple clamping mechanism to be mounted on or incorporated into the handle 3 to enable the core 3 to translate with respect to the handle 3 only when the user releases the clamping mechanism.

Should the smoke alarm 6 be sounding when the user wishes to silence it, the smoke alarm disabling device 1 can be held by the handle 3 and used as a fan to momentarily dissipate smoke, with the bag 2 being used to fan away smoke from the vicinity of the smoke alarm 6. Once the smoke alarm 6 stops sounding, the user can then install the smoke alarm disabling device 1 over the smoke alarm 6 in the fashion just described.

FIG. 9 shows a typical rectangular smoke alarm 24 having an upper ridge area 24-B, sides 24-C, and a top surface 24-D. FIG. 10 shows how the embodiment of FIG. 1 would contract to lock the open end 7 of the bag 2 around the rectangular contour of the smoke alarm 24. The smoke alarm disabling device 1 would function with a rectangular smoke alarm 24 just as described earlier in the case of a circular smoke alarm 6.

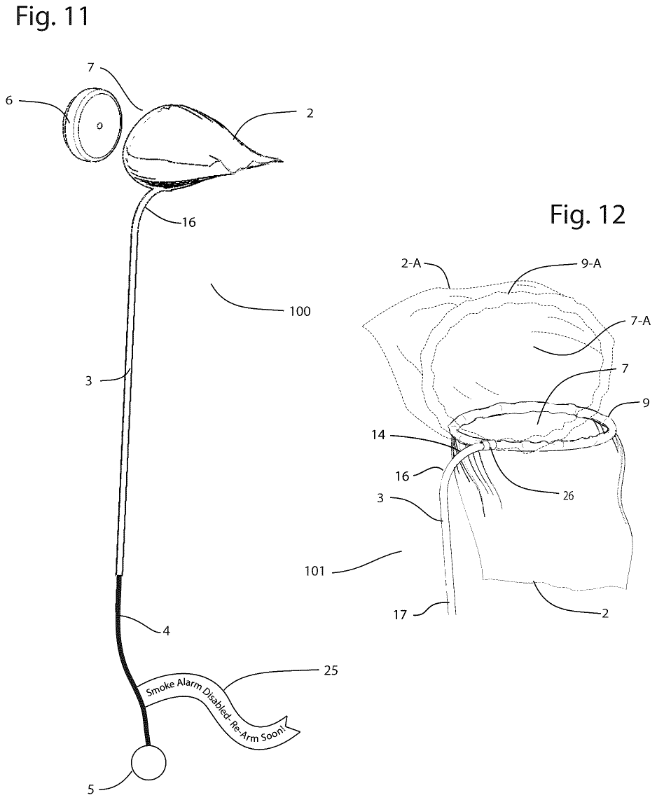

FIG. 11 shows another embodiment of a smoke alarm disabling device 100 for use with wall-mounted smoke alarms. In this embodiment, the plane of the open end 7 of the bag 2 is approximately in the same plane as is the curved portion 16 of the handle 3. As in the previous embodiment, when the expanded open end 7 of the bag 2 is placed over a smoke alarm 6 and then pressed against the mounting surface for the smoke alarm 6, the grippable member 5 can be pulled to contract the open end 7 of the bag 2 tightly against the periphery of the smoke alarm 6. The smoke alarm disabling device 100 can then be released by the user, and it will hang from the smoke alarm 6 until the device 100 is no longer needed and is removed by the user.

The wall on which the smoke alarm 6 is mounted will then act as a closure to the open end 7 of the bag 2 since the material of the bag 2 in the vicinity of the passageway 9 of the bag 2 will effectively act as a seal around the open end 7 of the bag 2. Thus, smoke from outside the bag 2 will be prevented from reaching the smoke alarm 6, and the smoke alarm 6 will remain silent while the smoke alarm disabling device 100 is left in position.

As described earlier with respect to an embodiment for use with a ceiling-mounted smoke alarm, this embodiment for use with wall-mounted smoke alarms can also be used to fan away smoke if the smoke alarm 6 is sounding prior to the smoke alarm disabling device 100 being put in place over the smoke alarm 6.

FIG. 11 also shows how a ribbon 25 or other warning label can be attached to the smoke alarm disabling device 100 to call attention to the fact that the device 100 should be removed as soon as possible.

FIG. 12 shows another embodiment of a smoke alarm disabling device 101 adapted to be used with either wall-mounted or ceiling-mounted smoke alarms 6. In this embodiment, a rotatable joint 26 is incorporated into the upper portions of the handle 3.

The rotatable joint 26 allows a short length of the handle 3 near its proximal end 14 to rotate about the axis of the proximal end 14 of the handle 3 with respect to the rest of the curved portion 16 of the handle 3. In one position of the rotatable joint 26, the smoke alarm disabling device 101 can have the configuration shown in FIG. 7 with the plane of the open end 7 of the bag 2 roughly perpendicular to the straight portion 17 of the handle 3. In that configuration, the smoke alarm disabling device 101 will be suited for use with ceiling-mounted smoke alarms 6.

When the joint 26 is rotated approximately 90 degrees, the plane of the open end 7 of the bag 2 will be approximately the same as the plane of the curved portion 16 of the handle 3. This is shown in FIG. 12 with a dashed outline showing the alternate position of the bag 2. The alternate position of the bag 2 is indicated by the dashed outline and with “-A” appended to the various part numbers. In this alternate position, the open end 7-A of the bag 2 is in approximately the same plane as the straight portion 17 of the handle 3. Thus, the bag 2 extends out to the side rather than downwardly, and the smoke alarm disabling device 101 can be positioned over a wall-mounted smoke alarm.

The rotatable joint 26 can have many possible forms. For example, it may be of a well-known type utilizing an internal or external sleeve, it can utilize friction to hold it in position, or it can incorporate a positive locking device of some well-known type. The joint 26 could also be made in two sections that could disconnect and then snap together in either of the two configurations shown in FIG. 12.

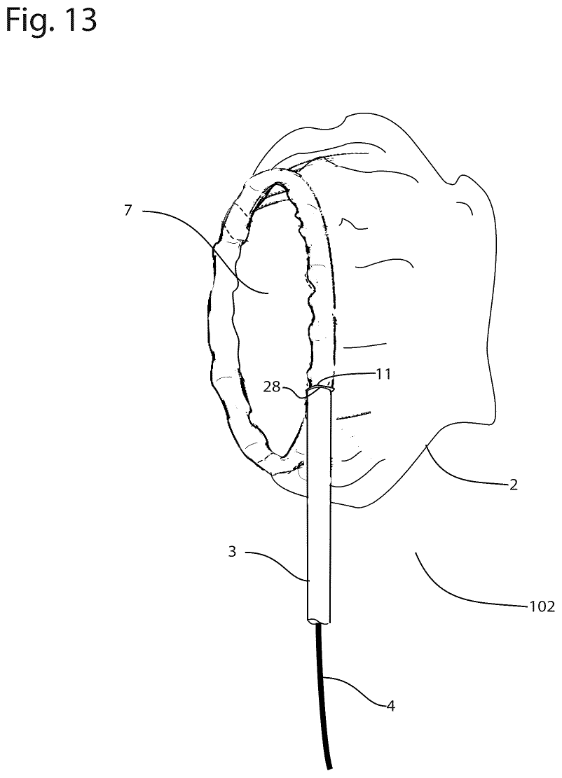

FIG. 13 shows a cut-away view of another embodiment of a smoke alarm disabling device 102 for use with wall-mounted smoke alarms. In this embodiment, the handle 3 need not have a curved portion 16 as in the earlier described embodiments. As shown in FIG. 13, the handle 3 can be straight or otherwise shaped where the proximal end 28 of the handle 3 enters into the passageway 9 of the bag 2 through the first opening 11. In the device 102 shown in FIG. 13, the handle 3 lies approximately in the plane of the open end 7 of the bag 2 and of the hoop region 21 of the core 4 which is surrounded by the periphery of the open end 7 of the bag 2.

FIG. 13 also shows the bag 2 with the open end 7 slightly reduced in size as it might appear when the core 4 is partially pulled out of the passageway 9 to contract the bag 2 around a round smoke alarm.

As with the embodiment shown in FIG. 11, when the expanded open end 7 of the bag 2 is placed over a smoke alarm and then pressed against the mounting surface for the smoke alarm, the grippable member 5 can then be pulled to contract the open end 7 tightly against the periphery of the smoke alarm. The smoke alarm disabling device 102 can then be released by the user, and it will hang from the smoke alarm 6 until it is no longer needed and is removed by the user.

As described earlier, the surface on which the smoke alarm is mounted will then act as a closure to the open end 7 of the bag 2 since the material near the periphery of the open end 7 of the bag 2 will effectively act as a seal around the open end 7 of the bag 2. Thus, smoke from outside the bag 2 will be prevented from reaching the smoke alarm 6, and it will be silenced while the smoke alarm disabling device 102 is left in position.

The smoke alarm disabling device 102 of FIG. 13 can also be used to fan away smoke if the smoke alarm 6 is sounding prior to the smoke alarm disabling device 102 being put in place over the smoke alarm. The structure of this embodiment may be otherwise the same as that of the embodiment of FIG. 1.

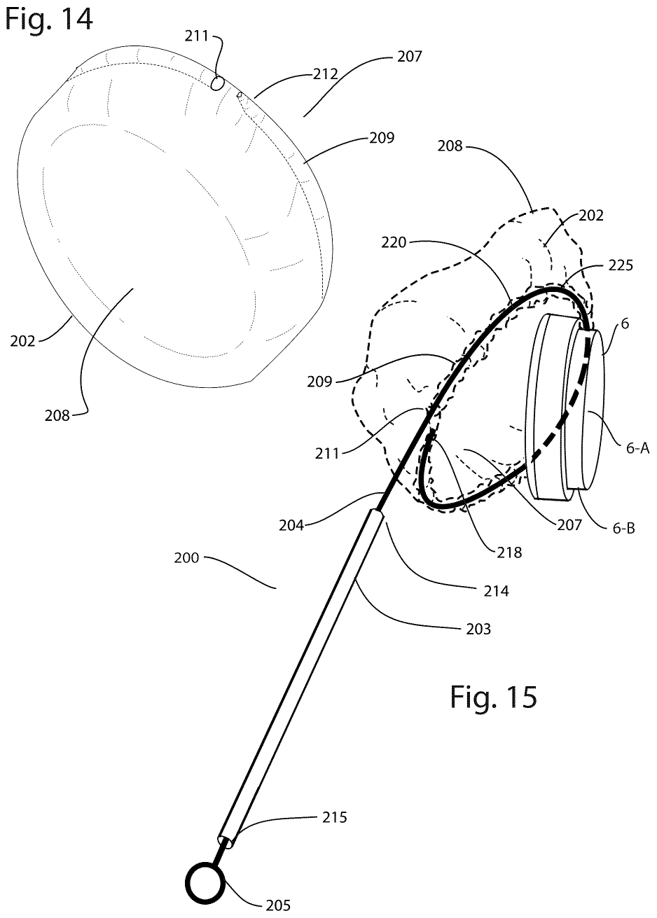

FIG. 14 shows a bag 202 having a passageway 209 which surrounds an open end 207 of the bag 202 and which is open at one end 211 and closed at the other end 212. This bag 202 could be used in place of the bag 2 in each of the embodiments described earlier but with the proximal end of the core 4 attached within the bag 202 near the closed end 212 of the passageway 209 as described earlier.

FIG. 15 shows another embodiment of a smoke alarm disabling device 200 according to the present invention. The illustrated disabling device 200 includes a bag 202 like the one shown in FIG. 14, a handle 203, and an actuator in the form of a core 204 which can translate with respect to the handle 203 in the lengthwise direction of the handle 203. A typical wall-mounted smoke alarm 6 is also shown in relation to the smoke alarm disabling device 200.

The core 204, which may have essentially the same structure as the core 4 in the preceding embodiments, enters the passageway 209 in the open end 207 of the bag 202 through the opening at end 211 of the passageway 209. As described in the earlier embodiments, the core 204 curves around within the passageway 209. As is the case with respect to the passageway 9 in the previous embodiments, the passageway 209 can be continuous, or it can be composed of multiple discrete sections formed by loops or other structures. The core 204 has a proximal end 218 which is attached to the bag 202 near to the opening at end 211 of the passageway 209. The core 204 may exit from the passageway 209 through an opening, or it may terminate within the closed end 212 of the passageway 209 near the open end 211. Attachment of the core 204 to the bag 202 can be done by any convenient method such as cementing, stitching, tying a knot, or other well-known technique.

In this embodiment, the handle 203 has a proximal end 214 which is not attached to the bag 202. The core 204 passes through portions of the handle 203 and may end as with the earlier embodiments of a smoke alarm disabling device with a grippable member 205.

The structure of the handle 203 permits portions of the core 204 to slide within the handle 203 without buckling. The handle 203 may be tubular as shown in FIG. 15, or it may have several discrete passageways to constrain the core 204 and prevent buckling within the handle 203. It is also possible for the core 204 to be supported on the exterior of the handle 203. As described earlier, the core 204 may have portions that are stiffened to help prevent buckling in the regions between the proximal end 214 and the distal end 215 of the handle 203.

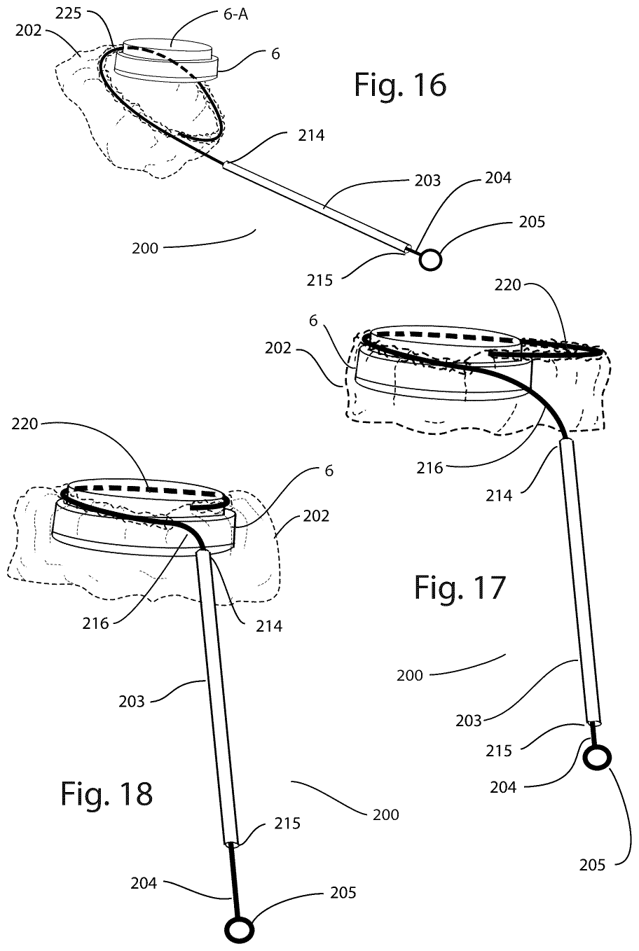

This smoke alarm disabling device 200 is suited for use with either wall-mounted smoke alarms 6 or ceiling-mounted smoke alarms 6. FIG. 15 shows the use of the device 200 with a wall-mounted smoke alarm, and FIGS. 16 through 18 show in further detail how the device 200 works with a ceiling-mounted smoke alarm. The process for using the device 200 is essentially the same.

As shown in FIG. 15, with a wall-mounted smoke alarm 6, a user can manipulate the handle 203 by holding the handle 203 near its distal end 215. The grippable member 205 can be used to slide the proximal end 214 of the handle 203 upward along the core 204 towards the opening at one end 211 of the passageway 209 of the bag 202 until it is sufficiently close to the bag 202 that the stiffness of the core 204 will allow the user to control the position of the opening 207 of the bag 202 by manipulating the handle 203. In this way a user can then position a portion 225 of a loop 220 of the core 204 within the open end 207 of the bag 202 to hook over and engage an upper portion of the surface of the smoke alarm 6 near the wall surface on which the smoke alarm 6 is mounted, as is illustrated in FIG. 15. FIG. 16 shows the same operation being done with a ceiling-mounted smoke alarm 6. In this figure, a portion 225 of the core 204 of the smoke alarm disabling device 200 is being manipulated so as to press the open end 207 of the bag 202 against both the surface 6-A on which the smoke alarm 6 is mounted and an upper portion of the periphery of the smoke alarm 6.

As shown in FIG. 17, the user can then manipulate the grippable member 205 and the handle 203 so as to press the loop 220 of the core 204 flat against the mounting surface for the smoke alarm 6 (either a wall or a ceiling as the case may be). The bag 202 will completely surround the smoke alarm 6 with the open end of the bag 207 fully expanded by the loop 220 of the core 204. A portion 216 of the core 204 extending outside the handle 203 can flex as needed to allow the open end 207 of the bag 202 to lie flush against the mounting surface for the smoke alarm 6. The bending stiffness of the core 204 will be sufficient to act as a spring holding the open end 207 of the bag 202 in close contact with the mounting surface for the smoke alarm 6.

Once the user has positioned the smoke alarm disabling device 200 in the position shown in FIG. 17, the user can then manipulate the grippable member 205 and pull the core 204 outwardly from within the handle 203. The core 204 will act as a drawstring, constricting the loop 220 tightly around the smoke alarm 6. The user can then release the smoke alarm disabling device 200, and it will remain hanging from the smoke alarm 6 until it is removed by the user. The open end 207 of the bag 202 will form a seal against the mounting surface for the smoke alarm 6, and the bag 202 will prevent smoke from entering the smoke alarm while the smoke alarm disabling device 200 is in use.

As described with the earlier embodiments, the smoke alarm disabling device 200 can be waved near a smoke alarm to dissipate smoke near the smoke alarm and temporarily silence the smoke alarm if the smoke alarm is sounding before the smoke alarm disabling device 200 is put in place over the smoke alarm.

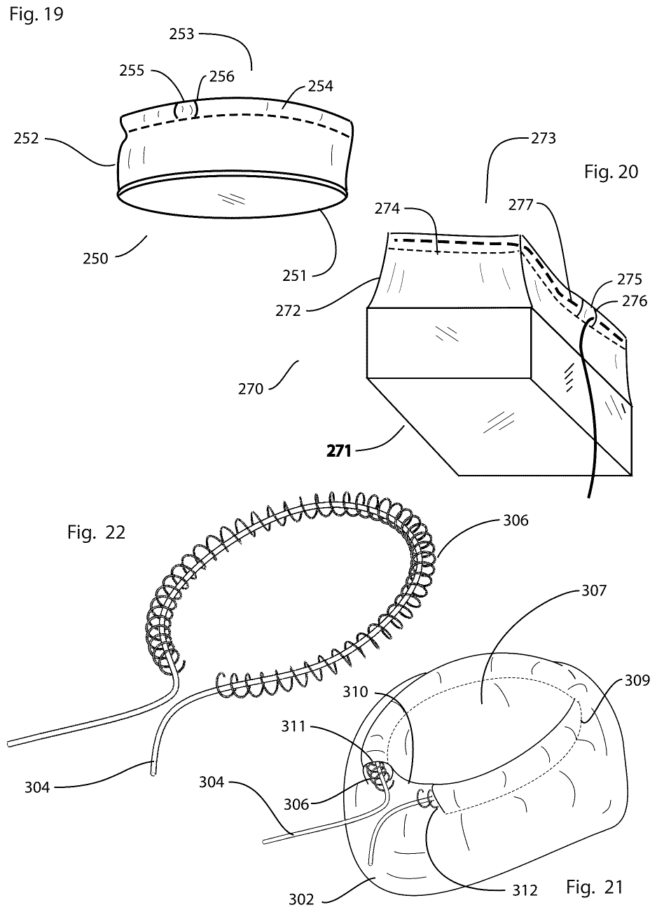

FIGS. 19 and 20 schematically illustrate other examples of bags which can be used in a smoke alarm disabling device according to the present invention. In these examples, portions of the bag are made of a flexible material as described earlier, and other portions are made of rigid materials such as stiff fabric, plastic, wood, metal, or compressed fibers, to give a few examples.

FIG. 19 shows a bag 250 with a rigid round bottom portion 251 and a flexible skirt 252 connecting the rigid bottom 251 with the open end 253 of the bag 250. The open end 253 of the bag 250 is surrounded by a passageway 254, which in this example is formed by a hem. The passageway 254 has one or more openings 255 allowing a flexible core to enter the passageway 254 (such as through one end 256 of the passageway 254) as described in the earlier embodiments. Smoke alarm disabling devices using this bag 250 would work as described before, with the upper edge of the flexible skirt 252 contracting when the core of the device is manipulated so as to lock the smoke alarm disabling device to a smoke alarm. Although FIG. 19 shows the skirt 252 of the bag 250 as being closed by a flat, rigid plate-shaped bottom 251, the closure could also be made by another shape, such as a rigid tubular or cylindrical portion with a closed bottom.

FIG. 20 shows a bag 270 with a rigid rectangular bottom portion 271 and a flexible skirt 272. The flexible skirt 272 connects the rigid bottom portion 271 with the open end 273 of the bag 270. The open end 273 is surrounded by a passageway 274, which in this example is formed by a hem and which includes one or more openings 275 allowing a core 277 to enter the passageway 274 such as through one end 276 of the passageway 274 as described earlier. A smoke alarm disabling device using this bag 270 would work as described before, with the upper edge of the flexible skirt 272 contracting when the core of the smoke alarm disabling device is manipulated so as to lock the smoke alarm disabling device to a smoke alarm. This bag 270 might be particularly suited for use with rectangular smoke alarms. Although FIG. 20 shows the bottom portion 271 of the bag 270 as being in the form of a rigid box, it could also take a different form, such as that of a rigid rectangle attached to the flexible skirt 272.

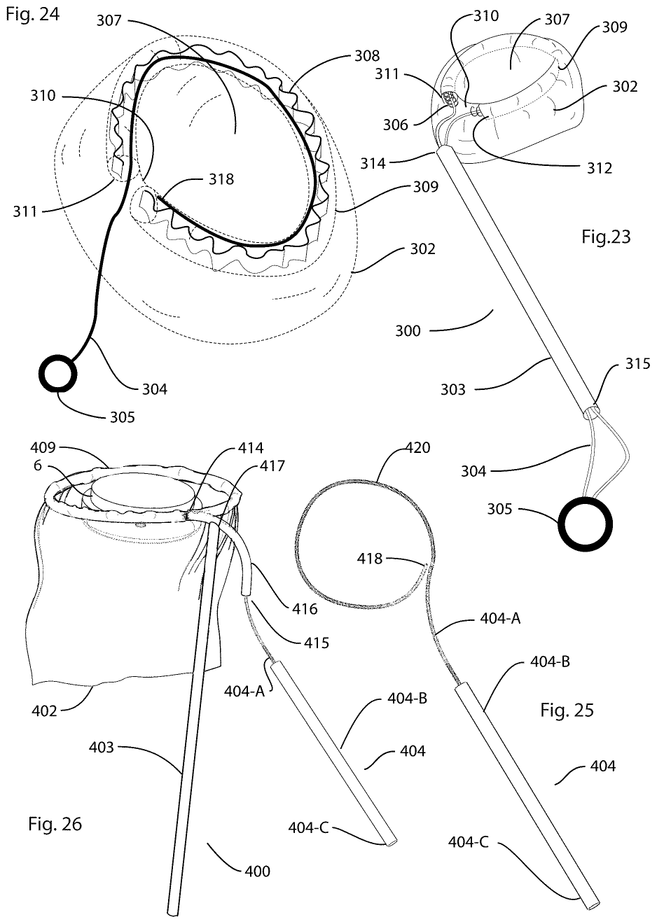

FIG. 21 illustrates an example of a bag 302 equipped with a coil compression spring 306 to hold an open end of the bag 307 in an expanded state, FIG. 22 illustrates the coil spring 306 removed from the bag 302, and FIG. 23 illustrates an embodiment of a smoke alarm disabling device 300 equipped with the bag 302 shown in FIG. 21. As shown in these figures, the bag 302 includes a passageway 309 extending around the open end 307 of the bag 302. The coil spring 306 is disposed inside the passageway 309 and extends out of openings 311 and 312 at opposite ends of an open portion 310 of the bag 302. A flexible core 304 is surrounded by the coil spring 306 and extends inside the passageway 309 over the length of the passageway 309 and out of the ends of the passageway 309. The coil spring 306 will act to keep the open end 307 of the bag 302 expanded to the limits defined by the circumference of the open end 307 of the bag 302. The core 304 can act as a drawstring, compressing the coil spring 306 and thereby constricting the open end 307 of the bag 302 to a smaller periphery when a tensile force is applied to the core 304.

As shown in FIG. 23, the smoke alarm disabling device 300 includes a handle 303 with an opening 314 at its proximal end and another opening 315 at its distal end. The two ends of the flexible core 304 pass into opening 314 and pass out of the handle 303 through opening 315 and are then attached to a grippable member 305. When the core 304 is somewhat relaxed, the open end 307 of the bag 302 will be expanded by the coil spring 306 and can be looped over a smoke alarm as described earlier. The bag 302 is shown hanging loosely from the proximal end of the handle 303 by the core 304 without being directly attached to the handle 303, but it is also possible to directly attach the bag 302 to the handle 303. The proximal end of the handle 303 can move close to the open portion 310 of the bag 302 to stabilize the bag 302 and to aid in positioning it in relation to a smoke alarm. Once the bag 302 is in position, the two ends of the core 304 can be drawn tight with respect to the bag 302 and the handle 303 by manipulating the grippable member 305 with respect to the handle 303. In an alternative construction, the two ends of the drawstring-like core 304 can themselves serve as a grippable member, and they could be tied or otherwise attached to one another.

In order to prevent the open end 307 of the bag 302 from coming loose from a smoke alarm under the force exerted by the coil spring 306 after the bag 302 has been placed over and tightened around a smoke alarm but a user is no longer applying tension to the core 304, various arrangements can be employed to prevent the core 304 from translating with respect to the handle 303 and being drawn into the passageway 309 in the bag 302. For example, a clamping mechanism such as conventional cord lock such as is commonly used to prevent movement of cords on backpacks, jackets, coats, tennis shoes, and the like can be engaged with the core 304. The cord lock can be disposed in a convenient location where it can be easily operated by a user, such as on the exterior of the handle 303 near the distal end 315 of the handle 303. Alternatively, a cord lock could be built into the structure of the handle 303 itself with the core 304 passing through the cord lock. As another alternative, friction between the core 304 and the interior or other portion of the handle 303 could be sufficient to prevent the core 304 from translating with respect to the handle 303 under just the tensile force applied to the core 304 by the coil spring 306. As still another alternative, a user could wrap or tie the distal end of the core 304 around the handle 303 or releasably engage the core 304 with a notch or groove formed in the handle distal end of the handle 304 to temporarily prevent the core 304 from translating with respect to the handle 303.

The coil spring 355 shown in FIGS. 21-23 is merely one example of many arrangements by which the bag 302 could be held open when not being forced partially closed by a core 304. For example, the passageway 309 in the bag 302 could contain a spring curved to fit within the circumference of the open end 307 of the bag 302 but with a relaxed shape that is less curved. Another possible construction could use an undulating flat spring to try to keep the open end 307 of the bag 302 as wide as possible. FIG. 24 shows an example of a bag 302 having an undulating flat spring 308 disposed inside the passageway 309 in the bag 302 in place of the coil spring 306 shown in FIGS. 21-23. In this example, instead of the core 304 having both ends extending out of the passageway 309 at the open end 307 of the bag 302, the core 304 has a proximal end 318 which is secured to the bag 302, such as to the interior of the passageway 309, and only the distal portion of the core 304 extends to the exterior of the bag 302. As an alternative, the proximal end 318 of the core 304 may be secured to an unillustrated handle. The distal portion of the core 304 extends over the length of the unillustrated handle and out of the distal end of the handle, where it can be grasped by a user. The core 304 of the smoke alarm disabling device 300 shown in FIG. 23 may if desired be modified to have a structure like the core 304 shown in FIG. 24. Conversely, the core 304 shown in FIG. 24 may have a structure like that shown in FIG. 23 with both ends of the core 304 extending out of the distal end of a handle.

If the bag 302 shown in FIG. 24 is used as a stand-alone device without a handle, the bag 302 can be placed over a smoke alarm by hand by a user standing on a chair, for example, and the user can then pull on the core 304 to tighten the open end 307 of the bag 302 around the smoke alarm. To prevent the open end 307 of the bag 302 from expanding under the force of the spring 308 when the user is not applying tension to the core 304, some sort of clamping mechanism, such as a cord lock described above with respect to the embodiment of FIG. 23, can be mounted on the core 304 near the bag 302. The clamping mechanism will act as a stopper to prevent the core 304 from being pulled further into the passageway 309 in the bag 302. As a result, the open end 307 will remain tightened around the smoke alarm until the user manually releases the clamping mechanism.

The coil spring 306 shown in FIGS. 21-23 is merely one example of many arrangements by which the bag 302 could be held open when not being forced partially closed by a core 304. For example, the passageway 309 in the bag 302 could contain a spring curved to fit within the circumference of the open end 307 of the bag 302 but with a relaxed shape that is less curved. Another possible construction could use an undulating flat spring to try to keep the open end 307 of the bag 302 as wide as possible. FIG. 24 shows an example of a bag 302 having an undulating flat spring 308 disposed inside the passageway 309 in the bag 302 in place of the coil spring 306 shown in FIGS. 21-23. In this example, instead of the core 304 having both ends extending out of the passageway 309 at the open end 307 of the bag 302, the core 304 has a proximal end 318 which is secured to the bag 302, such as to the interior of the passageway 309, and only the distal portion of the core 304 extends to the exterior of the bag.

Pulling the core 304 in FIG. 24 partially out of the passageway 309 by means of a grippable member 305 attached to the core 304 would cause the open end 307 of the bag 302 to decrease in circumference. If desired, this arrangement could be used as a stand-alone smoke alarm disabling device, or it could be used as a component in conjunction with a handle as described earlier.

Instead of using a compression spring, the bag 302 could itself be made of a resilient or spring-like fabric or other material that would tend to hold the open end 307 of the bag 302 as wide as possible in the absence of forces from a core 304.

In addition, a spring (such as the coil spring 306, the undulating spring 308, or another flexural member) could be sewn or otherwise fastened to the open end 307 of the bag 302 rather than being enclosed in a passageway 309 of the bag 302. Such a construction could also serve to hold the open end 307 as wide as possible in the absence of forces from a core 304.

As mentioned earlier, a core of a smoke alarm disabling device according to the present invention need not be flexible over its entire length. FIG. 25 shows an example of a core 404 which includes both a flexible portion 404-A forming a proximal portion of the core 404 and a rigid portion 404-B forming a distal portion of the core 404. The flexible portion 404-A is bendable but at the same time is axially stiff to enable the flexible portion 404-A to act both in tension and compression. The rigid portion 404-B of the core 404 is rigid and not subject to buckling in ordinary use. For instance, it could be made in a rod-like form. The rigid portion 404-B has a distal end 404-C which can be grasped by a user during the operation of a disabling device. The flexible portion 404-A of the core 404 has a proximal end 418 which can extend through a passageway in the open end of a bag. When the flexible portion 404-A is installed within a passageway in a bag, a region of the flexible portion 404-A can be formed into a loop 420.

The core 404 shown in FIG. 25 can be installed in a handle of a smoke alarm disabling device in the same manner as the core 4 in any of the embodiments of FIGS. 1-18, with the distal end 404-C of the core 404 extending out of the distal end of a handle where the distal end 404-C can be grasped by a user and with the flexible portion 404-A of the core 404 extending out of the proximal end of the handle and into a passageway in a bag.

It is not necessary for an actuator (such as a core) of a smoke alarm disabling device according to the present invention to be primarily or even partially disposed within a handle of the device. FIG. 26 illustrates an embodiment of a smoke alarm disabling device 400 in which an actuator comprising the core 404 illustrated in FIG. 25 is disposed largely outside of a handle 403 of the device. The handle 403 comprises a body portion which supports a flexible bag 402 and a curved branch portion 416 secured to the proximal end 417 of the body portion of the handle 403. Since the core 404 does not extend through the body portion of the handle 403, the body portion may be either hollow or solid. On the other hand, the branch portion 416 is hollow over its entire length from its proximal end 414 to its distal end 415. The rigid portion 404-B of the core 404 may be disposed entirely outside of the handle 403, with the flexible portion 404-A of the core 404 extending through the branch portion 416 of the handle and into a passageway 409 formed in the upper end of the bag 402. The portion of the flexible portion 404-A of the core 404 within the passageway 409 curves around in the shape of a loop 420 as shown in FIG. 25, and the proximal end 418 of the flexible portion 404-A can be secured to the branch portion 416 of the handle 403 or to the upper end of the bag 402.

The smoke alarm disabling device 400 shown in FIG. 26 is shown as used with a ceiling-mounted smoke alarm 6. However, the disabling device 400 can be easily modified to enable it to be used with a wall-mounted smoke alarm 6, such as by installing a rotatable joint between the proximal end of the branch portion 416 of the handle 403 and the bag 402.

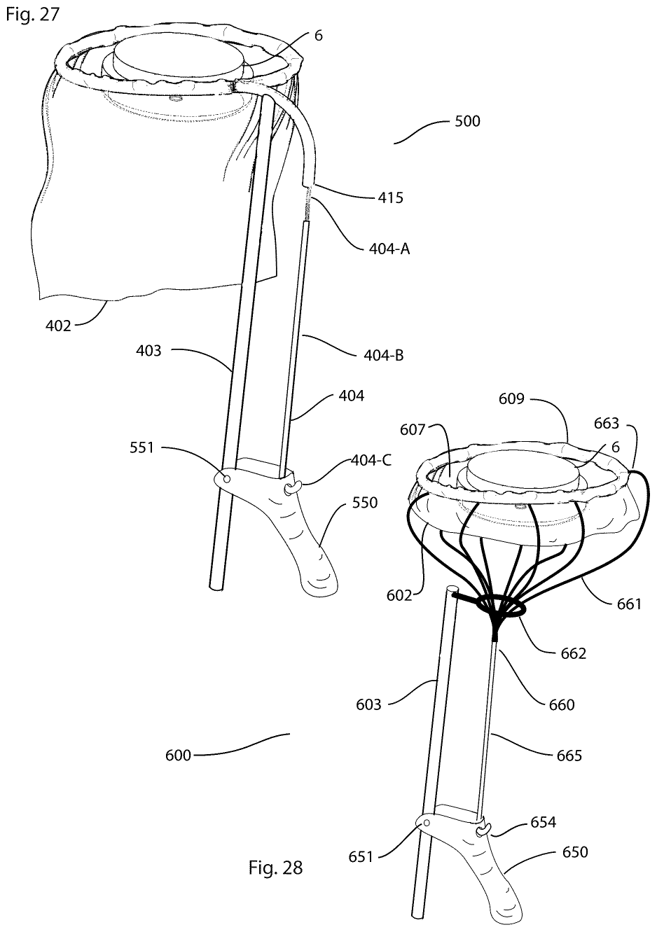

FIG. 27 illustrates another embodiment of a smoke alarm disabling device 500 according to the present invention. This embodiment is similar to the embodiment of FIG. 26, but it further includes a lever 550 which is pivotably mounted on the handle 403 at a pivot point 551. The distal end 404-C of the rigid portion 404-B of the core 404 is pivotably connected to the lever 550 so that the entire core 404 is translated in its lengthwise direction to expand or control the open end of the bag 402 when the lever 550 is rotated with respect to the handle 403. This arrangement enables the user to manipulate the lever 550 with the same hand that is holding the handle 403. Thus, a user can use the smoke alarm disabling device 500 to fan away smoke from the vicinity of a smoke alarm 6 with the bag 402 and to attach or detach the disabling device 500 with respect to a smoke alarm with a single hand.

FIG. 28 provides a pictorial overview of another embodiment of a smoke alarm disabling device 600 according to the present invention. In this embodiment, the disabling device 600 includes a cover in the form of a flexible bag 602, a handle 603, and an actuator comprising a bag opening and closing mechanism 660 and an optional bag control lever 650.

As in the earlier embodiments, the bag 602 is typically made of tightly woven fabric or other flexible sheet material capable of blocking smoke from passing through it from the outer surface of the bag 602 to the inside of the bag 602. The bag 602 has an adjustable open end 607 and a closed opposite end. The open end 607 of the bag 602 is surrounded by an upper edge 609 which may include a hem or other structures. The bag 602 is sized to enclose a typical smoke alarm 6 with which the smoke alarm disabling device 600 would be used.

In the embodiment shown in FIG. 28, the bag opening and closing mechanism 660 comprises a group of two or more flexible members 661 made of spring wire, for example. Each flexible member 661 is attached at its proximal end 663 to the upper edge 609 of the bag 602. The flexible members 661 curve around the outside of the bag 602 to accommodate the bag 602 and a smoke alarm 6 that might be within the bag 602. In this example, the flexible members 661 then have a reverse curve and pass through a funnel or ring-shaped hoop portion 662 attached to the handle 603. The distal ends of the flexible members 661 are then gathered together in a bundle forming or attached to a rigid member 665, such as a shaft. The distal end 654 of the rigid member 665 can then be used as a manipulable handle, or it can be pivotably attached to a manipulable lever 650 (similar to the one shown in FIG. 27) which is pivotably mounted on the handle 603 at a pivot point 651.

By properly choosing the geometry and the spring stiffness of the flexible members 661 and the angle at which they enter the funnel or ring-shaped hoop portion 662, the flexible members 661 can be designed to spring outwards against the funnel or ring shaped hoop portion 662, pulling the rigid member 665 in the direction of the funnel or ring-shaped hoop portion 662 and causing the open end 607 of the bag 602 to open outwardly to its fully open perimeter. In the absence of other forces, this would be the relaxed state of the bag 602.

By pulling the distal end 654 of the rigid member 665 away from the funnel or ring-shaped hoop portion 662, either by squeezing the lever 650 if the device is so equipped or by otherwise grasping or manipulating the rigid member 665, the flexible members 661 will be drawn into the funnel or ring-shaped hoop portion 662, and the proximal portions of the flexible members 661 will compress the upper edge 609 of the bag 602 so as to tightly seal it to the circumference of a smoke alarm 6 near the mounting surface for the smoke alarm 6. The various flexible members 661 will deflect as necessary during this process.

A detent mechanism, a latch or the like can be used to hold the lever 650 in a position in which the open end 607 of the bag 602 grips a smoke alarm 6 and prevent the smoke alarm disabling device 600 from inadvertently releasing from the smoke alarm 6, or the flexible members 661 can be designed with dimples that would engage with portions of the funnel or ring-shaped hoop portion 662 to act as detents and retain the smoke alarm disabling device 600 in position.

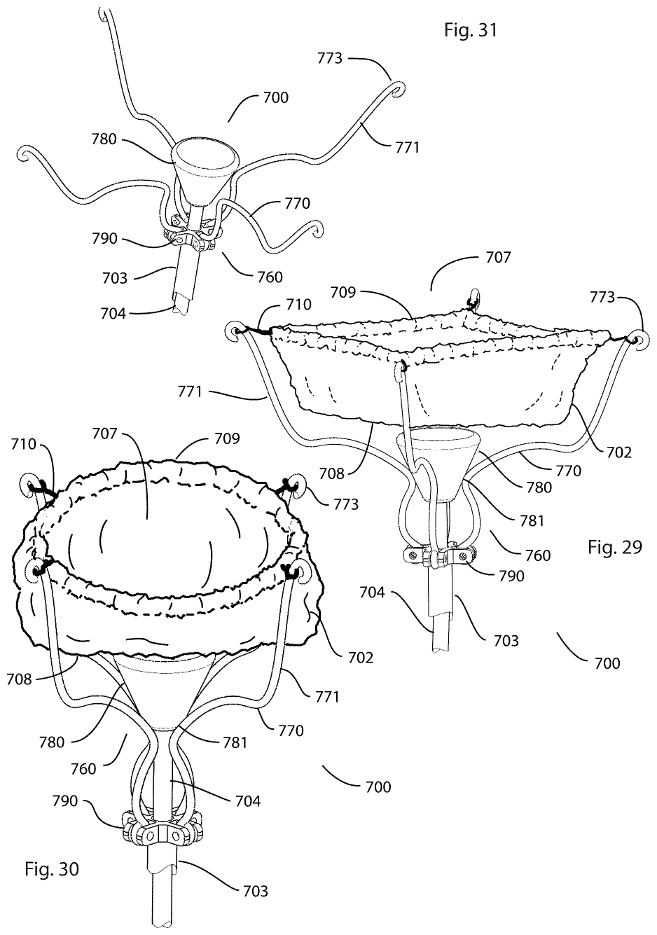

FIGS. 29, 30, and 31 show pictorial views of another embodiment of a smoke alarm disabling device 700 according to the present invention. FIG. 29 shows an upper portion of the disabling device 700 with a flexible bag 702 of the disabling device 700 in an expanded state, FIG. 30 shows the upper portion of the disabling device 700 from another angle with the bag 702 in a contracted state in which it can grasp a smoke alarm, and FIG. 31 illustrates the upper portion of the disabling device 700 with the bag 702 removed for clarity.

As shown in these figures, in this embodiment, the smoke alarm disabling device 700 includes the flexible bag 702, an elongated handle 703 which supports the bag 702 and enables a user of the disabling device 700 to position the bag 702 with respect to a smoke alarm, and a manually operated actuator 760 for expanding and contracting the bag 702.

The handle 703 has a proximal or upper end which supports the bag 702 and an unillustrated distal or lower end which can be held by a user during operation of the disabling device 700. The handle 703 preferably has a convenient overall length allowing the distal end of the handle 703 to be at a convenient height for manipulation by a user when the bag 702 is being positioned on or near a smoke alarm. In addition, the length of the handle 703 is preferably such as to allow a user to temporarily fan smoke away from a smoke alarm by waving the bag 702 in the vicinity of the smoke alarm. In the present embodiment, the handle 703 is hollow over its entire length but it is not restricted to any particular structure.

As in the previous embodiments, the bag 702 is typically made of tightly woven fabric or other flexible sheet material capable of blocking smoke from passing through from the outer surface of the bag 702 to the inside of the bag 702. The bag 702 has an adjustable open end 707 and a closed end 708 and is sized to fit over a typical smoke alarm. The open end 707 includes an elasticized upper edge 709 which can be stretched to allow the open end 707 to fit over a smoke alarm but which will contract to conform to the perimeter of a smoke alarm in the absence of outward forces applied to the upper edge 709. The upper edge 709 may include a passageway containing an elastic material or a spring, or elasticity of the upper edge 709 may be produced by the elastic properties of the bag 702 itself. For instance, the bag 702 may be formed from a rubberized material with an upper edge that would, in its relaxed state, be smaller than the circumference of a smoke alarm but which could be stretched to fit over a smoke alarm.

The actuator 760 comprises an elongated core 704 which is slidably supported by the handle 703, a lever assembly 770 which is mounted on the proximal end of the handle 703, and a cam 780 which is secured to the proximal end of the core 704 and operatively engages the lever assembly 770. The core 704 is shown disposed inside the handle 703, but it may instead be supported on the exterior of the handle 703.

The lever assembly 770 includes three or more actuating levers 771 which are pivotably connected to the handle 703 at their distal ends by a bracket 790 mounted on the exterior of the handle 703. The proximal ends 773 of the actuating levers 771 are connected to the open end 707 of the bag 702 by any convenient method. For example, the proximal ends 773 of the actuating levers 771 could be sewn to the bags 702, or they could be connected to the bag 702 by suitable connectors 710, such as cords, wires, rings, or the like.

The cam 780 has a shape which tapers towards the proximal end of the handle 703. For example, in the present embodiment, the cam 780 has a generally frustoconical shape which decreases in diameter towards the proximal end of the handle 703. Each of the actuating levers 771 has a portion in sliding contact with a contact point 781 on the outer surface of the cam 780 as the cam 780 moves towards or away from the proximal end of the handle 703. When the cam 780 is pulled inwards by the core 704 towards the proximal end of the handle 703, the contact between the cam 780 and the actuating levers 771 causes the proximal ends 773 of the actuating levers 771 to spread outwards and increase the area of the open end 707 of the bag 702. Conversely when the cam 780 moves away from the proximal end of the handle 703 as shown in FIG. 30, the contact points 781 between the actuating levers 771 and the outer surface of the cam 780 move towards the lower end of the cam 780. As a result, the proximal ends 773 of the actuating levers 771 are pulled towards each other by the upper edge 709 of the bag 702, and the open end 707 of the bag 702 contracts. In the state shown in FIG. 30, the upper edge 709 of the bag 702 is free to conform to the shape of portions of the shell of a smoke alarm if one is contained within the bag 702. If the lever assembly 770 includes four actuating levers 771, the open end 707 of the bags 702 will be drawn into a somewhat square shape such as the shape shown in FIG. 29 when the open end 707 is expanded by the actuating levers 771.

The core 704 may have any structure which enables it to act in tension to move the cam 780 from a raised position such as shown in FIG. 30 in which the open end 707 of the bag 702 is contracted to a lowered position such as shown in FIG. 29 in which the open end 707 of the bag 702 is expanded. Depending upon the force exerted on the actuating levers 771 by the bag 702 when the bag 702 is in an expanded state, the force applied to the cam 780 by the actuating levers 771 may be sufficient to move the cam 780 from a lowered position to a raised position in the absence of a force restraining the movement of the core 704 with respect to the handle 703. In this case, it is sufficient for the core 704 to be able to act in tension. On the other hand, if some upward force needs to be applied to the cam 780 in order to move the cam 780 from a lowered position to a raised position, the core 704 will need to be able to act in compression as well as in tension. The core 704 may be rigid or flexible over all or a portion of its length, depending upon the shape of the handle 703. The core 704 has an unillustrated distal end which extends outside of the unillustrated distal end of the handle 703 to enable a user of the disabling device 700 to apply an axial force to the core 704. If desired, the distal end of the core 704 may be equipped with a grippable member which can be gripped by a user. It is also possible for the distal end of the core 704 to be connected to a lever or other mechanism for applying an axial force to the core 704 similar to the lever 650 shown in FIG. 28, for example.

The disabling device 700 shown in FIGS. 29-31 is intended primarily for use with a smoke alarm mounted on a ceiling. However, it can be easily modified for use with a wall-mounted smoke alarm by forming the handle 703 with a curved portion near its proximal end so that the open end 707 of the bag 702 faces horizontally when the handle 703 is held vertically.

What is claimed is:

1. A smoke alarm disabling device comprising:
a cover which is impervious to smoke and is sized to fit over a smoke alarm and has an open end which can be expanded and contracted;
an elongated handle which supports the cover; and
an actuator operatively connected to the open end of the cover to switch the open end of the cover between an expanded state and a contracted state when an axial force is applied to the actuator.

2. A smoke alarm disabling device as claimed in claim 1 wherein the cover comprises a bag comprising a flexible material, and the open end of the cover comprises an open end of the bag.

3. A smoke alarm disabling device as claimed in claim 2 wherein the bag includes a passageway extending around a periphery of the open end of the bag, and the actuator includes a flexible portion disposed inside the passageway.

4. A smoke alarm disabling device as claimed in claim 3 wherein the bag has a hem extending around the open end of the bag, and the passageway is formed inside the hem.

5. A smoke alarm disabling device as claimed in claim 1 wherein application of an axial tensile force to the actuator contracts the open end of the cover and application of an axial compressive force to the actuator expands the open end of the cover.

6. A smoke alarm disabling device as claimed in claim 1 wherein a portion of the actuator is rigid.

7. A smoke alarm disabling device as claimed in claim 1 wherein the actuator is flexible over its entire length.

8. A smoke alarm disabling device as claimed in claim 1 wherein the actuator extends through an interior of the handle over an entire length of the handle.

9. A smoke alarm disabling device as claimed in claim 1 wherein the cover is rotatable with respect to the handle to enable the cover to be placed over a wall-mounted smoke alarm or a ceiling-mounted smoke alarm.

10. A smoke alarm disabling device as claimed in claim 1 wherein the cover includes a spring which applies a force to the open end of the cover acting to expand the open end, and application of a tensile axial force to the actuator acts to contract the open end of the bag.

11. A smoke alarm disabling device as claimed in claim 1 wherein the open end of the cover contracts in the absence of an outward force applied to the open end, and the application of an axial tensile force to the actuator applies a force to the open end of the bag to expand the open end of the bag.

12. A smoke alarm disabling device as claimed in claim 1 wherein the actuator is supported by the handle for movement with respect to the handle in first and second lengthwise directions of the handle, movement of the actuator with respect to the handle in the first lengthwise direction acts to expand the open end of the cover, and movement of the actuator with respect to the handle in the second lengthwise direction acts to contract the open end of the cover.

13. A smoke alarm disabling device as claimed in claim 12 wherein the actuator comprises a material selected from metal wire, a flexible spline, extruded plastic tubing, extruded plastic line, and wire rope.

14. A smoke alarm disabling device as claimed in claim 3 wherein: the handle has a bore extending between first and second lengthwise ends of the handle;
the actuator has a midportion which is slidably disposed in the bore, a distal portion which extends out of the first lengthwise end of the handle, and a proximal portion which extends out of the second lengthwise end of the handle and passes through the passageway in the bag and has an end which is secured to prevent the end of the proximal portion from being pulled out of the passageway; and translation of the distal portion of the actuator with respect to the handle in a first lengthwise direction of the handle contracts the open end of the bag, and translation of the distal portion of the actuator with respect to the handle in the second lengthwise direction of the handle expands the open end of the bag.

15. A smoke alarm disabling device as claimed in claim 14 wherein the end of the proximal portion of the actuator is secured to the bag or the second lengthwise end of the handle to prevent the end of the proximal portion from being pulled out of the passageway.

16. A smoke alarm disabling device comprising:
a smoke alarm mounted on a surface of a room; and
a smoke alarm disabling device as claimed in claim 1 disposed with the cover of the smoke alarm disabling device over the smoke alarm and the open end of the cover contracted around the smoke alarm and contacting the surface on which the smoke alarm is mounted, the smoke alarm disabling device being supported entirely by the smoke alarm.

17. A method of disabling a smoke alarm comprising:
positioning the smoke alarm disabling device of claim 1 using the handle with the open end of the cover opposing a smoke alarm and in the expanded state; placing the cover over the smoke alarm until the open end of the cover contacts a surface on which the smoke alarm is mounted; and operating the actuator to contract the open end of the cover around the smoke alarm to form a seal between the cover and the smoke alarm.

18. A method as claimed in claim 17 wherein placing the cover over the smoke alarm includes contacting the open end of the cover against a surface on which the smoke alarm is mounted.

19. A method as claimed in claim 17 which includes silencing of the smoke alarm by waving the smoke alarm disabling device of claim 1 near the smoke alarm to dissipate smoke near the alarm.
